(19) United States
(12) Patent Application Publication
(10) Pub. No.: US 2014/0055261 A1
(43) Pub. Date: Feb. 27, 2014

(54) Disaster Prevention Device

(71) Applicant: Ta-Tsun Su, New Taipei City (TW)

(72) Inventor: Ta-Tsun Su, New Taipei City (TW)

(21) Appl. No.: 13/592,203

(22) Filed: Aug. 22, 2012

(51) Int. Cl. G08B 1/00

(52) U.S. Cl. 340/532

(57) ABSTRACT

A disaster prevention device contains a detecting unit and a control unit. The detecting unit includes a single crystal microprocessor connecting with a temperature detector, a gas detector, a smoke detector, a sound generator, an automatic dialing circuit, and a wireless transmitter circuit, such that when a gas stove is not turned off to cause a continuous gas burning, an abnormal temperature or smoke generates, and the wireless transmitter circuit transmits a wireless signal. The control unit includes a wireless receiver circuit, an electromagnetic valve connecting with the wireless receiver circuit, and the electromagnetic valve having an air inlet coupled with a gas hose and an air outlet connected with a gas inlet hose of the gas stove, such that after the wireless receiver circuit receives the wireless signal from the wireless transmitter circuit of the detecting unit, the electromagnetic valve is driven to turn off gas.

### FIELD OF THE INVENTION

The present invention relates to a disaster prevention device, and more particularly to a disaster prevention device for gas which allows detecting an abnormal temperature, gas, or smoke because a user forgets turning off the gas, and then allows making sound to warn the user, thereafter firefighter or police is called by using an automatic dialing function after such an emergency is not relieved in a set time.

### BACKGROUND OF THE INVENTION

Typically, a user sometimes forgets turning off the gas stove in cooking, then a fire disaster will happen to hurt human life or damage belongings.

The present invention has arisen to mitigate and/or obviate the afore-described disadvantages.

### SUMMARY OF THE INVENTION

The primary object of the present invention is to provide a disaster prevention device for gas which allows detecting an abnormal temperature, gas, or smoke because a user forgets turning off the gas, and then allows making sound to warn the user, thereafter firefighter or police is called by using an automatic dialing function after such an emergency is not relieved in a set time.

To obtain the above objective, a trash can with a deodorization and sterilization function provided by the present invention contains:

a detecting unit including a single crystal microprocessor connecting with a temperature detector, a gas detector, a smoke detector, a sound generator, an automatic dialing circuit, and a wireless transmitter circuit, such that when a gas stove is not turned off to cause a continuous gas burning, an abnormal temperature or smoke generates, and the wireless transmitter circuit transmits a wireless signal;

a control unit including a wireless receiver circuit, an electromagnetic valve connecting with the wireless receiver circuit, and the electromagnetic valve having an air inlet coupled with a gas hose and an air outlet connected with a gas inlet hose of the gas stove, such that after the wireless receiver circuit receives the wireless signal from the wireless transmitter circuit of the detecting unit, the electromagnetic valve is driven to turn off gas.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view showing the assembly of a disaster prevention device for gas according to a preferred embodiment of the present invention.

FIG. 2 is a block diagram showing the electric circuit of the disaster prevention device for the gas according to the preferred embodiment of the present invention.

FIG. 3 is a perspective view showing the assembly of a control unit of the disaster prevention device for the gas according to the preferred embodiment of the present invention. FIG. 4 is a perspective view showing the application of the disaster prevention device for the gas according to the preferred embodiment of the present invention.

FIG. 5 is also a perspective view showing the application of the disaster prevention device for the gas according to the preferred embodiment of the present invention.

### DETAILED DESCRIPTION OF THE PREFERRED EMBODIMENTS

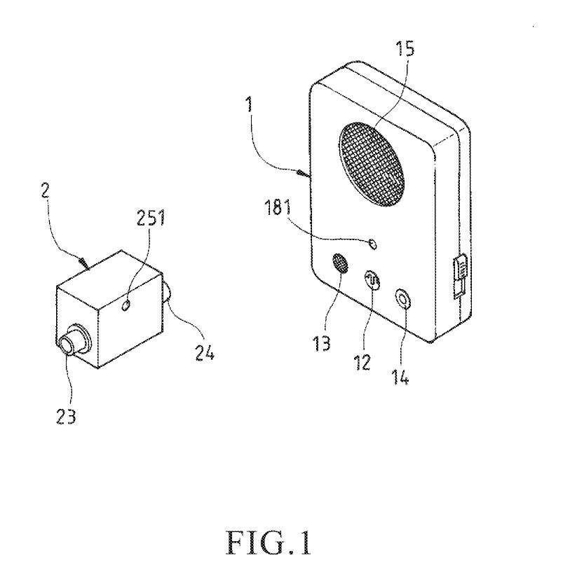

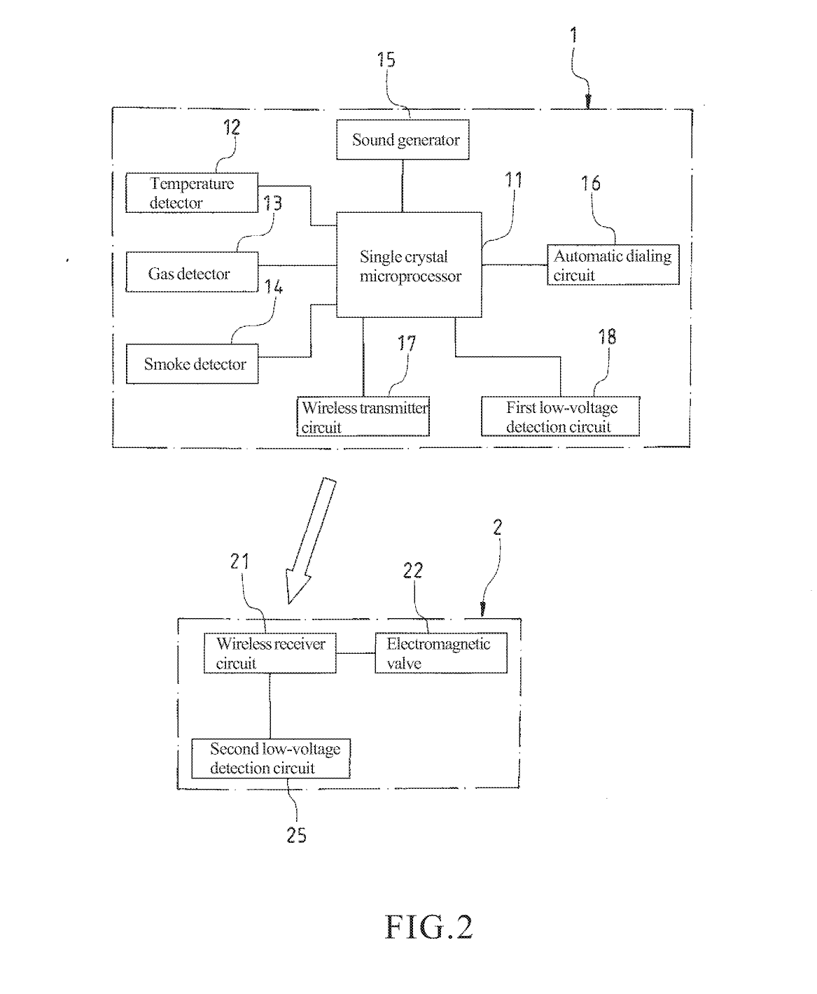

FIG. 1 is a perspective view showing the assembly of a disaster prevention device for gas according to a preferred embodiment of the present invention. FIG. 2 is a block diagram showing the electric circuit of the disaster prevention device for the gas according to the preferred embodiment of the present invention.

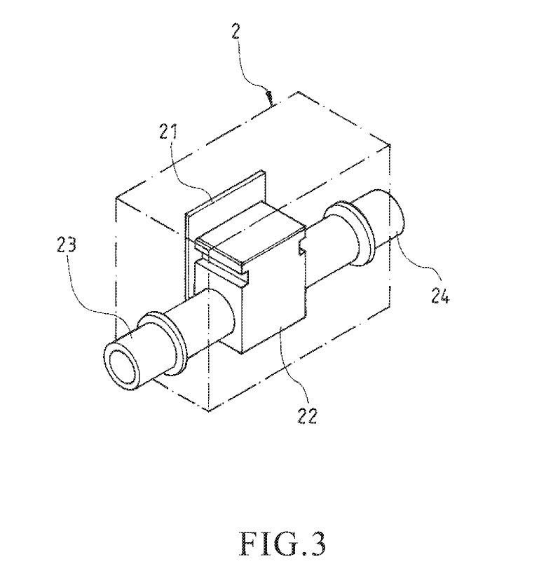

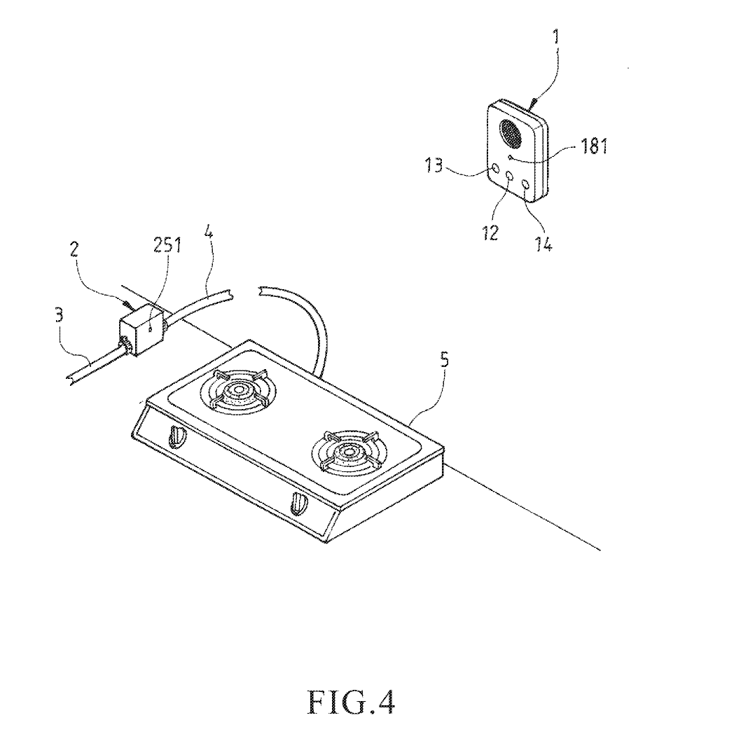

FIG. 3 is a perspective view showing the assembly of a control unit of the disaster prevention device for the gas according to the preferred embodiment of the present invention. With reference to

FIGS. 1-3, the disaster prevention device for the gas comprises a detecting unit 1 and a control unit 2. The detecting unit 1 includes a single crystal microprocessor 11 connecting with a temperature detector 12, a gas detector 13 to detect a gas leak, a smoke detector 14, a sound generator 15, an automatic dialing circuit 16, and a wireless transmitter circuit 17. The detecting unit 1 is supplied power by at least one first battery, and a first low-voltage detection circuit 18 is used to detect a capacity of the at least one first battery and has an first indicator 181 to display the capacity of the at least one first battery, thus reminding a user to replace at least one new first battery.

The control unit 2 includes a wireless receiver circuit 21, an electromagnetic valve 22 connecting with the wireless receiver circuit 21, and the electromagnetic valve 22 has an air inlet 23 and an air outlet 24. The control unit 2 is supplied power by the at least one second battery, and a second low-voltage detection circuit 25 is used to detect a capacity of the at least one second battery and has a second indicator 251 to display the capacity of the at least one second battery, thus reminding the user to replace at least one new second battery.

FIG. 4 is a perspective view showing the application of the disaster prevention device for the gas according to the preferred embodiment of the present invention. Accordingly, the detecting unit 1 is fixed at a predetermined position, and the air inlet 23 of the control unit 2 is coupled with a gas hose 3, the air outlet 24 is connected with a gas inlet hose 4 of a gas stove 5. Thereby, when the user forgets turning off the gas stove in cooking, the detecting unit 1 detects whether an abnormal temperature, gas, or smoke generates, if so, the wireless transmitter circuit 17 transmits a wireless signal toward the wireless receiver circuit 21 of the control unit 2 so that the wireless receiver circuit 21 receives the wireless signal, and then the electromagnetic valve 22 is driven to turn off the gas, thereafter the sound generator 15 of the detecting unit 1 makes a warning sound to warn the use. If the user does not relieve such an emergency in a set time, the automatic dialing circuit 16 dials phone numbers to call firefighter or police, thus obtaining safe purpose.

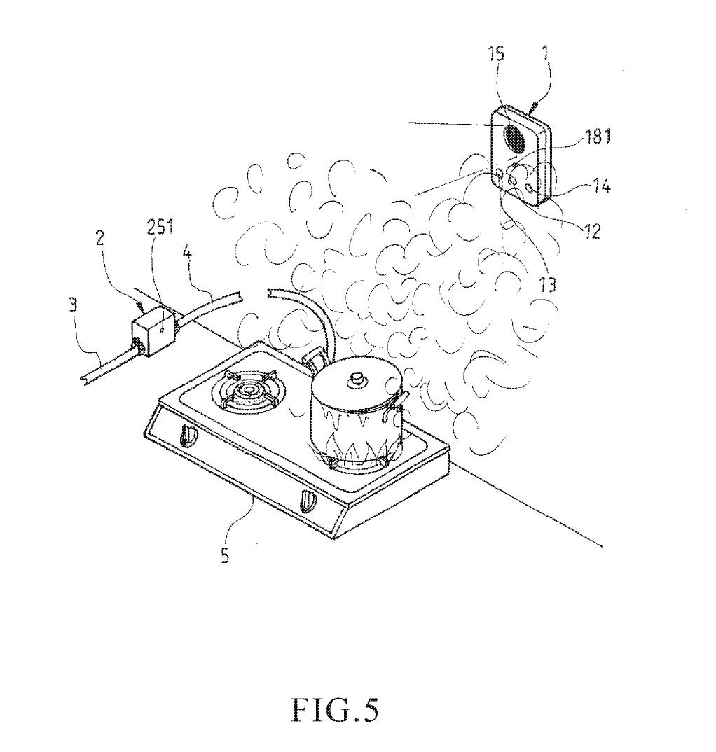

It is to be noted that the detecting unit 1 is fixed above the gas stove 5 as shown in FIG. 5 to detect temperature, gas, or smoke. If the abnormal temperature, gas, or smoke is not detected by the detecting unit 1, the control unit 2 controls a gas supply to the gas stove continuously.

FIG. 5 is also a perspective view showing the application of the disaster prevention device for the gas according to the preferred embodiment of the present invention. As shown in FIGS. 5, 2, and 3, if high temperature or/and heavy smoke generates because the user forgets turning off the gas stove 5 to cause a cautious gas burning, the detecting unit 1 detects the abnormal temperature or smoke, and then the wireless transmitter circuit 17 transmits the wireless signal toward the wireless receiver circuit 21 of the control unit 2 so that the wireless receiver circuit 21 receives the wireless signal, and then the electromagnetic valve 22 is driven to turn off the gas, thereafter the sound generator 15 of the detecting unit 1 makes the warning sound to warn the use. If the user does not relieve such an emergency in the set time, the automatic dialing circuit 16 dials the phone numbers to call firefighter or police, thus obtaining safe purpose.

Thereby, the disaster prevention device of the present invention includes different detectors and a plurality of wireless circuits to match with the control unit so that the abnormal temperature, gas, or smoke is detected, thereafter the gas is turned off and a warning sound is made to warn the user. In addition, if the user can not relieve the emergency in the set time, the automatic dialing circuit starts to call firefighter or police, thus obtaining safe purpose.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A disaster prevention device comprising:
a detecting unit including a single crystal microprocessor connecting with a temperature detector, a gas detector, a smoke detector, a sound generator, an automatic dialing circuit, and a wireless transmitter circuit, such that when a gas stove is not turned off to cause a continuous gas burning, an abnormal temperature or smoke generates, and the wireless transmitter circuit transmits a wireless signal;
a control unit including a wireless receiver circuit, an electromagnetic valve connecting with the wireless receiver circuit, and the electromagnetic valve having an air inlet coupled with a gas hose and an air outlet connected with a gas inlet hose of the gas stove, such that after the wireless receiver circuit receives the wireless signal from the wireless transmitter circuit of the detecting unit, the electromagnetic valve is driven to turn off gas.

2. The disaster prevention device as claimed in claim 1, wherein the detecting unit further includes an automatic dialing circuit for dialing phone numbers to call firefighter or police after the abnormal temperature or smoke is not relieved in a set time .

3. The disaster prevention device as claimed in claim 1, wherein the detecting unit is also connected with a gas detector for detecting a gas leak.
